(19) United States
(12) Patent Application Publication
(10) Pub. No.: US 2015/0173561 A1
(43) Pub. Date: Jun. 25, 2015

(54) SYSTEM FOR THE PREPARATION OF BEVERAGES

(71) Applicant: N.V. Nutricia, Zoetermeer (NL)

(72) Inventor: Jody James Foster, Ruddington (GB)

(73) Assignee: N.V. NUTRICIA, Zoetermeer (NL)

(21) Appl. No.: 14/413,588

(22) PCT Filed: Jul. 9, 2013
(86) PCT No.: PCT/EP2013/064439

§ 371 Date: Jan. 8, 2015

(30) Foreign Application Priority Data
Jul. 10, 2012 (EP) PCT/EP2012/063483

(51) Int. Cl. A47J 31/44; A61J 9/00; B65D 85/804

(52) U.S. Cl. CPC A47J 31/44; B65D 85/8043; A61J 9/00

(57) ABSTRACT

A system (1) for the preparation of beverages includes a beverage supply device (10) for delivering a dose of liquid through a liquid outlet (58) and a beverage receptacle (20) having a base having a liquid inlet (72). The supply device and beverage receptacle may be joined together using a coupling interface (44,46) for connecting the beverage supply device to the base of the beverage receptacle. This allows the liquid to flow into the bottle via the liquid inlet in the base of the beverage receptacle. The system may operate with capsule containing concentrated beverage and may include further accessories.

### BACKGROUND OF THE INVENTION

1. Field of the Invention

The invention relates to a system for the preparation of beverages and a device for filling beverage receptacles.

The present invention also relates to a system for the preparation of nursing bottles, in particular for making up amounts of infant formula for feeding to an infant. The invention further relates to a device for filling nursing bottles and to an improved nursing bottle for use with such a device.

2. Description of the Related Art

Breast-feeding is the preferred method of feeding infants. However, there are circumstances that make breast-feeding impossible or less desirable. In those cases infant formulae are a good alternative. The composition of modern infant formulae is adapted in such a way that it meets many of the special nutritional requirements of the fast growing and developing infant.

Infant formula has traditionally been packaged and sold in containers in the form of tins or tubs which allow for safe transport and storage, even after the container has been opened. A quantity of powder is measured out using a scoop into a nursing bottle where it is mixed with an amount of hot or warm water according to the recommendations of the producer.

Making up a bottle not only involves careful dosing of the powdered formula but also requires a correct amount of water at the correct temperature. If the feed is too hot, the infant may be scalded. If too cold, the infant may be disinclined to drink the full amount. Parents will be aware of the difficulties of cooling an overheated bottle while the baby cries impatiently for its feed. Achieving the correct temperature in a quick and easy manner is therefore of primary importance.

Attempts have been made to provide systems capable of automatically dosing infant formula into nursing bottles and making up the bottles ready for use. One such system is described in EP1633226 A2, whereby a quantity of powder is dosed into a bottle which is subsequently filled with water. Other systems use capsules of powdered infant formula to ensure a consistent dose. The sealed capsules also ensure that the infant formula may be stored hygienically prior to use. Machines that use such capsules to prepare bottles of infant formula are described in WO2010028282 and WO201142489. Although these machines may reduce some of the inconveniences of preparing infant formula, they are nevertheless rather bulky items and occupy considerable space on the already congested kitchen workspace. The bottles are filled in the conventional manner through their necks. The dispensing machines must therefore supply the formula from above necessitating a height sufficient to receive the nursing bottle beneath the outlet.

It would be desirable to find an alternative arrangement, facilitating easy dosing and preparation of infant formula. Such an arrangement should preferably be compact and occupy relatively little worktop space.

WO9830455 describes a method for feeding an infant by non-human milk including the steps of (a) feeding the infant by fore-milk equivalent having a volume of 30-60% of a total meal and a percentage of fat of 2.5-3.5%; and (b) feeding the infant by hind-milk equivalent having a volume of 40-70% of the total meal and a percentage of fat of 3.7-5.5%.

WO2006077259 describes a method of preparing a single serving of a nutritional composition comprising introducing water into a disposable capsule containing a unit dose of the composition in concentrated form so as to reconstitute the concentrated composition and operate opening means contained within the capsule to permit draining of the resulting liquid directly from the capsule into a receiving vessel. The method allows individual servings of nutritional compositions such as infant formulas to be prepared with substantially reduced or even eliminated risk of cross contamination from previously prepared servings.

WO2009143164 describes a fluid transfer assembly and method of fluid transfer. In one aspect, the fluid transfer assembly includes a fluid container having an opening in a bottom, a coupling device attached to the fluid container at the opening, and a filling device. The coupling device may include a valve biasing the coupling device in a closed fluid-tight position via magnetic attraction of opposing first and second components, each of the opposing first and second components including a magnetic material. The filling device may include a rigid member with a perimeter smaller than a perimeter of the fluid container opening, the rigid member including a passage along a longitudinal axis and one or more apertures through a sidewall in fluid communication with the passage, such that the coupling device is transitioned from the closed fluid-tight position to an open position by pressing the rigid member against one of the opposing first and second components, thereby placing the apertures in fluid communication with an interior of the fluid container.

### BRIEF SUMMARY OF THE INVENTION

In one broad form the present invention seeks to provide a beverage supply device for delivering a dose of liquid through a liquid outlet to a liquid inlet in a base of a beverage receptacle for the preparation of a beverage, the supply device comprising a coupling interface for connecting the supply device to the base of the beverage receptacle, whereby the liquid flows into the beverage receptacle via the liquid inlet characterized in that a replaceable accessory is connectable to the beverage supply device or the coupling interface in the place of the beverage receptacle, the replaceable accessory being selected from the group comprising: a sterilizing unit; a bottle warming unit; a food warming unit; a drink warming unit; a sterile water dispenser; a blender; and a drink maker.

The device can further comprise a source of water and a formula mixing chamber in communication with the source of water, whereby concentrated beverage can be mixed with water in the mixing chamber and delivered to the liquid outlet.

In another broad form the present invention seeks to provide a beverage supply device for delivering a dose of liquid through a liquid outlet to a liquid inlet in a base of a beverage receptacle for the preparation of a beverage, the supply device comprising a coupling interface for connecting the supply device to the base of the beverage receptacle, whereby the liquid flows into the beverage receptacle via the liquid inlet in use, characterized in that the device further comprises a source of water and a mixing chamber in communication with the source of water, whereby concentrated beverage can be mixed with water in the mixing chamber and delivered to the liquid outlet.

The mixing chamber can be a single use capsule containing concentrated beverage.

The coupling interface typically comprises a piercing element for piercing the capsule. The coupling interface may comprise a valve actuator, arranged to selectively open the liquid inlet. The coupling interface typically comprises a mechanical connection to the base of the beverage receptacle.

The device may further comprise a heater for heating the dose of liquid prior to delivery. The heater typically heats water prior to water being mixed with concentrated beverage.

The device may further comprise a source of pressure for pressurising the dose of liquid for delivery.

The beverage receptacle can have the liquid inlet located at an underside of the base, wherein the liquid outlet is oriented in use to direct the dose of liquid upwards into the beverage receptacle.

The device can further comprise a controller for controlling operation of the device. The device can further comprise a user-interface operatively connected to the controller.

The device can further comprise a detection element, arranged to provide a signal to the controller in response to detection of the base of the beverage receptacle.

The beverage receptacle can include at least one of a beaker and a nursing bottle.

The beverage may include an infant formula.

In a broad form the present invention seeks to provide a system for the preparation of beverages comprising:
a beverage supply device for delivering a dose of liquid through a liquid outlet;
a beverage receptacle having a base having a liquid inlet; and,
a coupling interface for connecting the supply device to the base of the beverage receptacle, whereby the liquid flows into the beverage receptacle via the liquid inlet in use, characterized in that the system further comprises a replaceable accessory, connectable to the beverage supply device or the coupling interface in the place of the beverage receptacle, the replaceable accessory being selected from the group comprising: a sterilizing unit; a bottle warming unit; a food warming unit; a drink warming unit; a sterile water dispenser; a blender; and a drink maker.

The system can further comprise a capsule containing a quantity of concentrated beverage to be mixed with water for delivery to the beverage receptacle.

In another broad form the present invention can provide a system for the preparation of beverage receptacles comprising:
a beverage supply device for delivering a dose of liquid through a liquid outlet;
a beverage receptacle having an upper portion for affixing a drinking teat and a base having a liquid inlet;
a coupling interface for connecting the beverage supply device to the base of the beverage receptacle, whereby the liquid flows into the beverage receptacle via the liquid inlet in use, characterized in that system further comprises a capsule containing a quantity of concentrated beverage to be mixed with water for delivery to the beverage receptacle.

The system capsule can further comprise an agitating arrangement arranged to agitate a content of the capsule, for example to agitate the beverage in the capsule for mixing with the water. The capsule can also be a pre-packaged single-use capsule.

The beverage receptacle can further comprising a coupling interface for coupling the beverage to the beverage supply device for filling of the beverage receptacle through the liquid inlet.

The beverage receptacle may be a nursing bottle having an upper portion for affixing a drinking teat and the base having the liquid inlet.

The coupling interface can comprise a piercing element for engagement with a pierceable element on the supply device.

The coupling interface can comprise a selectively operable valve, arranged to open to allow flow through the liquid inlet.

The selectively operable valve is typically a pressure actuated, one-way valve. The selectively operable valve can be opened by engagement by a valve actuator carried by the supply device.

The coupling interface typically comprises a mechanical connection to the supply device. The coupling interface may also comprise a mixing chamber in which concentrated beverage can be mixed with water and delivered to the liquid inlet.

In another broad form the present invention can provide a nursing bottle having an upper portion for affixing a drinking teat and a base having a liquid inlet, the nursing bottle further comprising a coupling interface for coupling the nursing bottle to an infant formula supply device for filling of the nursing bottle through the liquid inlet characterized in that the liquid inlet is located at an underside of the base, whereby in use liquid flows upwards into the beverage receptacle.

The coupling interface can comprise a piercing element for engagement with a pierceable element on the supply device. The coupling interface can also comprise a selectively operable valve, arranged to open to allow flow through the liquid inlet. The selectively operable valve may be a pressure actuated, one-way valve, which is opened by engagement by a valve actuator carried by the supply device.

The coupling interface typically comprises a mechanical connection to the supply device.

The coupling interface can comprise a formula mixing chamber in which concentrated beverage can be mixed with water and delivered to the liquid inlet.

In another broad form the present invention seeks to provide a pre-packaged single-use capsule comprising a bottom, a circumferential wall and a closing foil defining an internal chamber containing a dose of concentrated beverage, further comprising means for sealing engagement with a liquid supply device and with a base of a beverage receptacle allowing the contents of the capsule to be delivered upwards from the capsule into the bottle.

In another broad form the present invention seeks to provide a method of preparing a beverage receptacle having an upper portion for affixing a drinking teat and a base having a liquid inlet, the method comprising:
engaging the liquid inlet with a liquid outlet of an beverage supply device; and
supplying liquid from the liquid outlet through the liquid inlet to fill the beverage receptacle through its base, characterized in that the method further comprises providing a single-use capsule containing concentrated beverage and the method comprises supplying water through the capsule to produce reconstituted beverage for delivery to the beverage receptacle.

### BRIEF DESCRIPTION OF THE DRAWINGS

The features and advantages of the invention will be appreciated upon reference to the following drawings of a number of exemplary embodiments, in which:

FIG. 1 shows a frontal view of a system according to a first embodiment of the invention;

FIG. 2 shows a partially transparent perspective view of the system according to FIG. 1;

FIG. 3 shows a partially transparent perspective view of a capsule as shown in FIG. 2;

FIGS. 4 to 7 show frontal cross-sectional views of the system of FIG. 1 during use;

FIG. 8 shows a frontal cross-sectional view of a second embodiment of the invention prior to assembly;

FIG. 9 shows the embodiment of FIG. 8 in an assembled state;

FIG. 10 shows the embodiment of FIG. 9 in use;

FIG. 11 shows a partial cross-sectional view of a third embodiment of the invention prior to connection;

FIG. 12 shows the embodiment of FIG. 11 in a connected state;

FIG. 13 shows the system of FIG. 1 including further accessories; and,

FIG. 14 shows the system of FIG. 1 including a beaker.

### DESCRIPTION OF ILLUSTRATIVE EMBODIMENTS

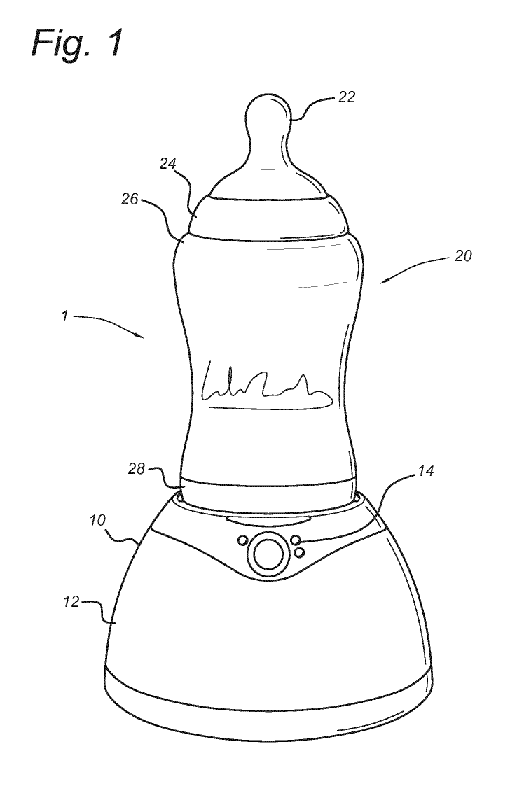

FIG. 1 shows a system 1 for the preparation of nursing bottles. The system 1 comprises an infant formula supply device 10 and a nursing bottle 20. The supply device 10 includes a reservoir 12 for water and a user interface 14. The bottle 20 has a teat 22 held by a locking ring 24 to a neck 26 of the bottle 20. A base 28 of the bottle 20 engages with the supply device 10.

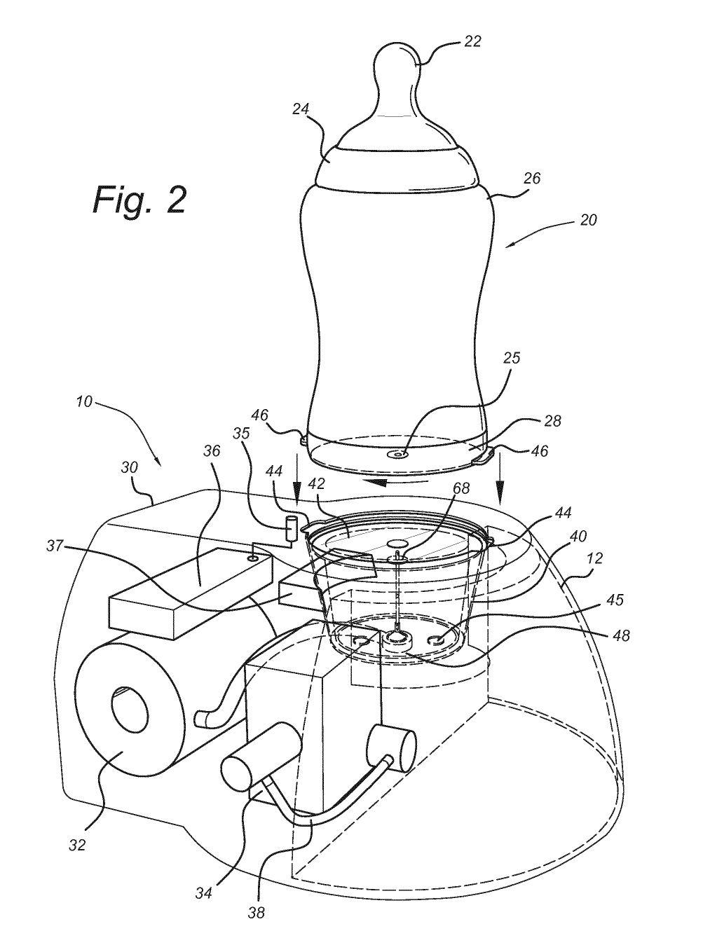

FIG. 2 shows the system of FIG. 1 in further detail in a partially transparent perspective view. The supply device 10 includes a housing 30 in which are contained a heater 32, a pump 34, a controller 36 and suitable connections 38. The supply device 10 also has a proximity detector 35, which functions to provide a signal in response to correct positioning of the bottle 20 onto the supply device 10 and an agitator 37. Further details of the internal features and connections are omitted for the sake of clarity although the skilled person will understand that additional components may be present as required, including sensors, actuators, filters, safety devices, power supplies and the like. At an upper surface of the housing 30 is located a recess 40. The recess 40 contains a capsule 42 which will be described in further detail below. Also provided around a rim of the recess 40 is a bayonet groove 44. The bottle 20 has corresponding bayonet lugs 46 on its base 28, which engage with the bayonet groove 44 to lock the bottle 20 securely in place on the housing 30. Also visible in the base 28 of the bottle 20 is a pre-slit seal 25 covering a liquid inlet. At the base of the recess 40, there is provided an outlet nozzle 48. The outlet nozzle 48 is connected via connections 38 to receive water from the heater 32, which in turn is connected via the pump 34 to the reservoir 12. Around the nozzle 48 are apertures 45 giving access to the reservoir 12.

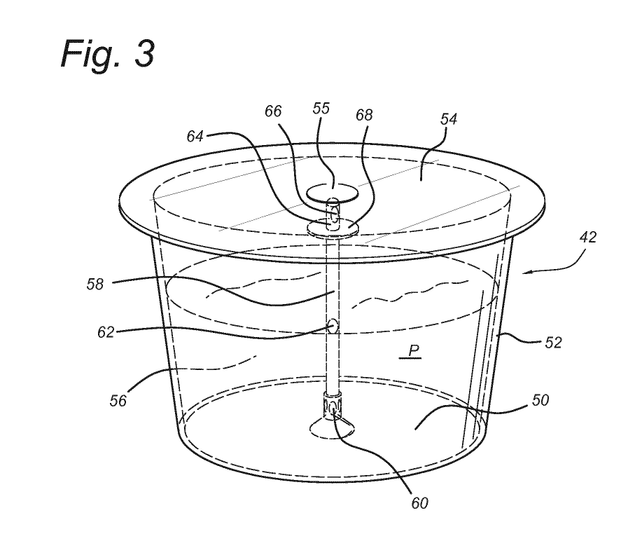

FIG. 3 shows a partially transparent perspective view of the capsule 42 of FIG. 2. The capsule 42 has a bottom 50, a circumferential wall 52 and a closing foil 54 defining an internal chamber 56 containing powdered infant formula P. Arranged centrally within the chamber 56 is an outlet spike 58. The outlet spike 58 has inlet openings 60 at its base and an outlet opening 62 at its mid-point, leading to an axially extending lumen 64 which exits at a blunt point 66. Adjacent to the point 66 there is provided a disk 68, the function of which will be further described below. The bottom 50 and wall 52 are formed of plastic material and the wall 52 is resilient. The spike 58 is formed of relatively rigid plastic. Overlying the spike 58 at the centre of the foil 54 is a membrane 55 which can be pierced without causing ripping of the foil 54. The foil 54 is formed of plastic laminate material including a barrier layer of EVOH. The membrane is formed of silicone rubber. The skilled person will understand that various materials may be used for forming the elements of the capsule 42 according to the required functionality and the above indicated materials are merely exemplary.

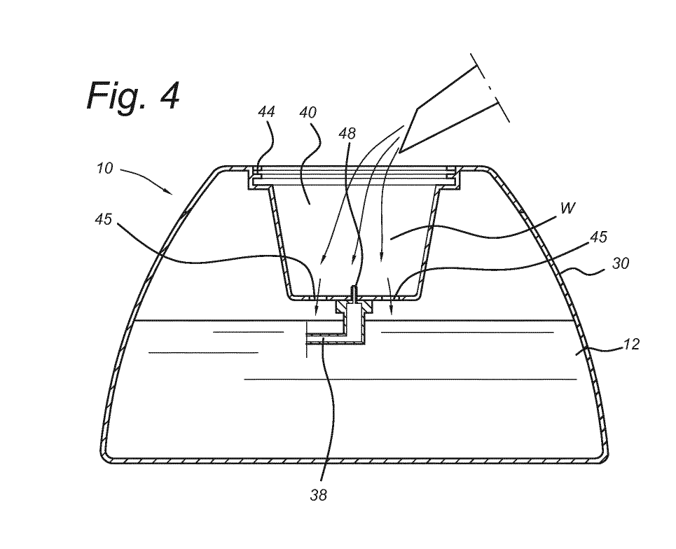

Operation of the system 1 of FIGS. 1 to 3, will now be described with reference to FIGS. 4 to 7, which show various stages of the operation.

FIG. 4 shows a frontal cross-sectional view of the supply device 10, with the bottle 20 and capsule 42 removed. Water W can be filled into the reservoir 12 via the apertures 45 provided in the recess 40.

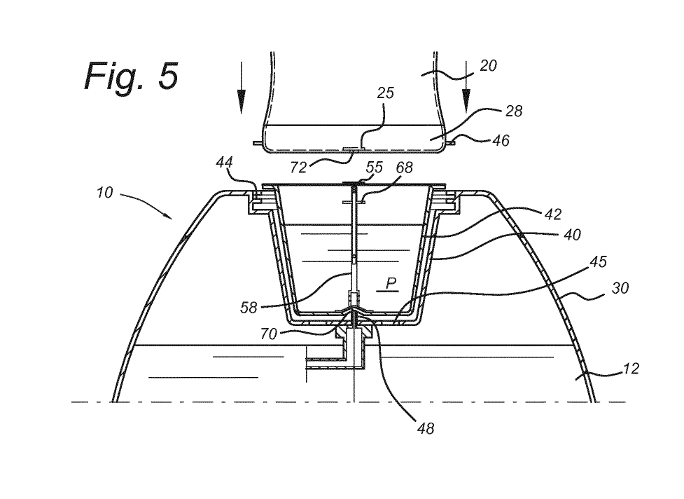

FIG. 5 shows a similar view to FIG. 4 with a capsule 42 containing powdered infant formula P in position in the recess 40, prior to connection of a bottle 20. As may be seen, the capsule 42 rests on the nozzle 48 which is aligned with the outlet spike 58 within the capsule 42. Also visible in this view is a dimple 70 in the underside of the capsule 42 which serves to locate it with respect to the nozzle 48. The bottle 20 is positioned ready for connection, with bayonet lugs 46 aligned for entry into bayonet grooves 44 and with liquid inlet 72 aligned with membrane 55.

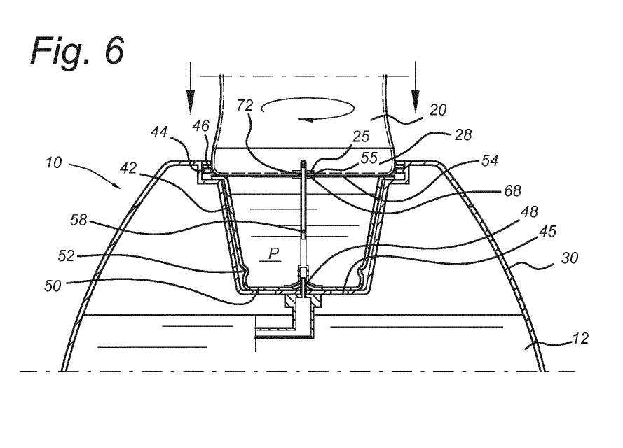

FIG. 6 shows a similar view to FIG. 5 after placing the bottle 20 in position on the supply device 10 and locking it into position by engagement of bayonet groove 44 and lugs 46. As the bottle 20 is pushed downwards, the nozzle 48 is forced upwards through the bottom 50 of the capsule 42 and into the underside of spike 58. At the same time, the wall 52 of the capsule 42 partially collapses, allowing the foil 54 to move downwards onto the spike 58. The spike 58 pierces the membrane 55 until it is retained against further progress by the disk 68. In this position, the spike protrudes upwardly through the liquid inlet 72 and through the pre-slit seal 25.

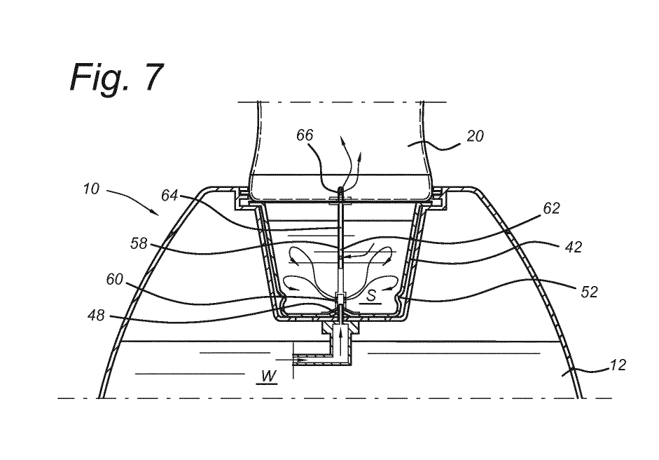

FIG. 7 shows a similar view to FIG. 6 in which operation of the infant formula supply device 10 has commenced. In use, a user initiates operation via the user interface 14. Under the control of controller 36, pump 34 is activated to pump a quantity of water W through the heater 32 to the nozzle 48. The water is heated to the desired temperature as it flows through the heater 32. The water enters the capsule 42 via nozzle 48 and inlet openings 60 in the base of the spike 58. The pressure and flow is such that a swirling effect is created within the capsule 42 whereby the powdered infant formula P is mixed to a slurry S. The inlet openings 60 may be directed tangentially to assist this swirling motion. The skilled person will be well aware of alternative designs that can achieve or improve on this mixing effect. During this process, the agitator 37 is operated to induce vibrations within the capsule to enhance mixing. The skilled person will also be aware of numerous arrangements that may be implemented to achieve such vibrations. As the capsule 42 fills, the pressure rises until the slurry is forced outwards via the outlet opening 62 and upwards via lumen 64 and through the blunt tip 66 into the bottle 20. Operation continues until the desired amount of water has been administered. This amount is automatically determined by the controller 36, although a manual override may also be provided should the user wish to terminate supply earlier for any reason. Once operation is complete, the bottle 20 may be disconnected from the supply device 10 and given to the baby. The capsule 42 can then be removed and disposed of. Removal is facilitated by the resilient wall 52 which causes the capsule 42 to rise from the recess after disconnection of the bottle 20.

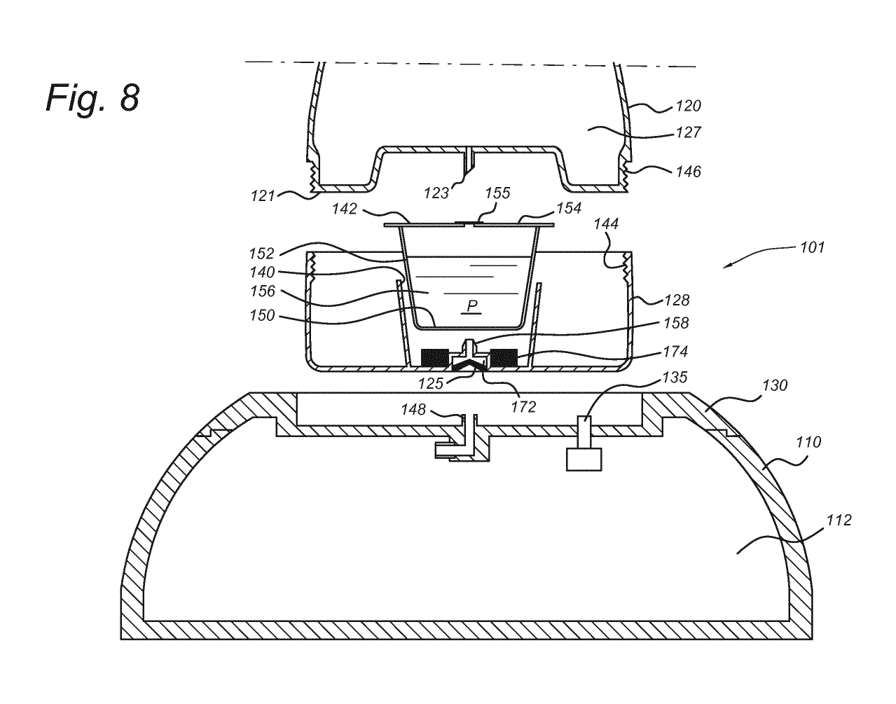

A second embodiment of the invention is disclosed in FIG. 8, which depicts a system 101 in a partially assembled frontal cross-sectional view. Like features to the first embodiment are identified using like references preceded by 100.

According to FIG. 8, a bottle 120 has a base 128 configured as a coupling interface for engagement with an infant formula supply device 110. The supply device 110 may be generally as described in the first embodiment and comprises a reservoir 112, a housing 130 and an outlet nozzle 148. Also provided on an upper surface of the housing 130 is a proximity detector 135. Further features of the supply device 110 such as heater, controller and pump are not shown for the sake of clarity but may be identical to those of the first embodiment. The bottle 120 has a partition wall 121 with a cannula 123 protruding downwards from its centre, communicating with an interior space 127 of the bottle 120. At its circumference, the partition wall 121 is provided with a screw thread 146.

According to the second embodiment, the base 128 has a recess 140 in which can be received a capsule 142. The base 128 has a screw thread 144, which can engage with the screw thread 146 on the bottle 120. The skilled person will understand that alternative connection arrangements may be employed including bayonet connections and the like. At the base of the recess 140 is provided a spike 158 which is surrounded by a sealing washer 174. At the lower side of the base 128, beneath the spike 158 and in open communication therewith is located a liquid inlet 172. Held within the liquid inlet is a one-way valve 125 of the duckbill type. The one-way valve 125 is configured to allow liquid to flow into the recess 140 from the liquid inlet 172 but not to return.

FIG. 8 also shows the capsule 142 containing powdered formula P in its internal chamber 156. The capsule 142 has a bottom 150 and a circumferential wall 152 with closing foil 154 and membrane 155 provided at its centre.

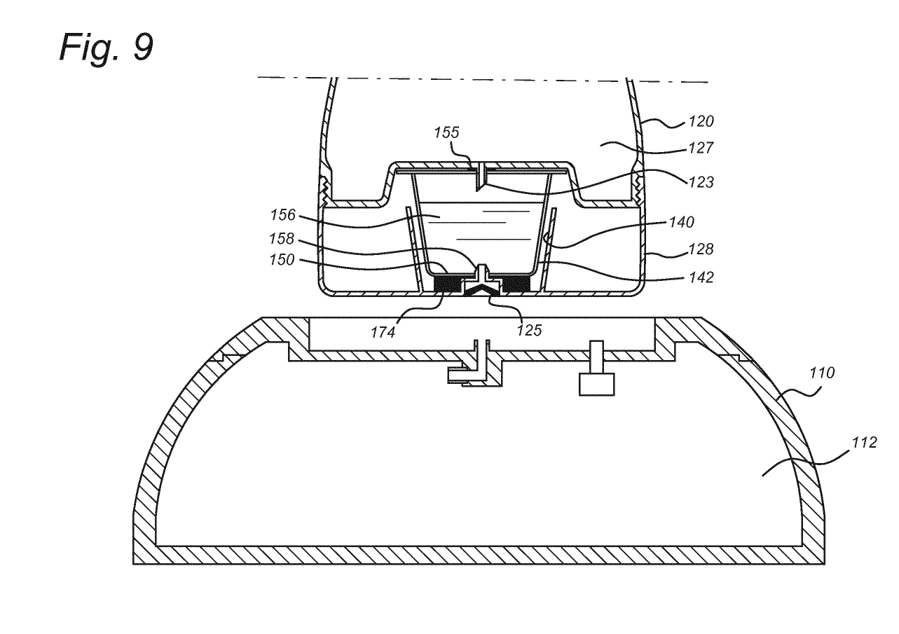

FIG. 9 shows a similar view to that of FIG. 8, with the bottle 120 and base 128 connected firmly together. The capsule 142 is held within the recess 140 and the cannula 123 penetrates through the membrane 155. In this embodiment, the membrane 155 is resilient and forms a seal around the cannula 123. The spike 158 has also penetrated through the bottom 150 of the capsule 142. It will be understood by the skilled person that the materials for these components are chosen in order to make this possible. The recess 140 supports the capsule 142 from all sides and as the bottle 120 and base 128 are screwed together, the capsule 142 is pressed downwards onto the sealing washer 174. In this condition, the interior space 127 of the bottle 120 and the internal chamber 156 of the capsule 142 are in communication via the cannula 123. They are sealed from the exterior by the presence of the one-way valve 125 which is in its closed condition.

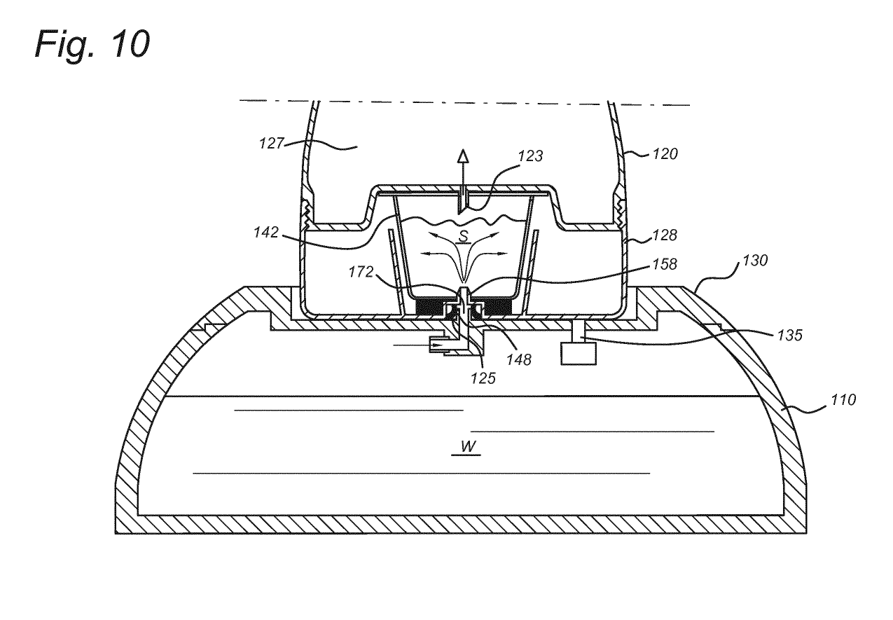

FIG. 10 shows a similar view of the second embodiment to FIG. 9, with the bottle 120 and base 128 engaged with the supply device 110 during liquid delivery.

In the condition as disclosed in FIG. 10, the base 128 of the bottle 120 has been pressed downwards onto the supply device 110 such that nozzle 148 enters into liquid inlet 172 and engages and opens the one-way valve 125. As the base 128 engages housing 130, the proximity detector 135 is depressed, causing the controller (not shown) to cause operation of the pump and heater to deliver heated water to the nozzle 148. The heated water flows under pressure through the liquid inlet 172, one-way valve 125 and spike 158 into the capsule 142 where it mixes with the powdered formula P to form a slurry S. The slurry S is subsequently flushed out of the capsule 142 through the cannula 123 into the interior space 127 of the bottle 120.

The supply device 110 automatically dispenses a predetermined amount of water to the bottle 120 and then ceases operation. At this point the bottle 120 may be removed from the supply device 110 and provided to an infant for feeding. During feeding, air is drawn in through the one-way valve 125 in a conventional manner and serves to flush out any residue from the capsule 142 which mixes with the remaining formula within the internal space 127 of the bottle 120. After terminating the feed, the bottle 120 and base 128 can be separated and the capsule 142 disposed of.

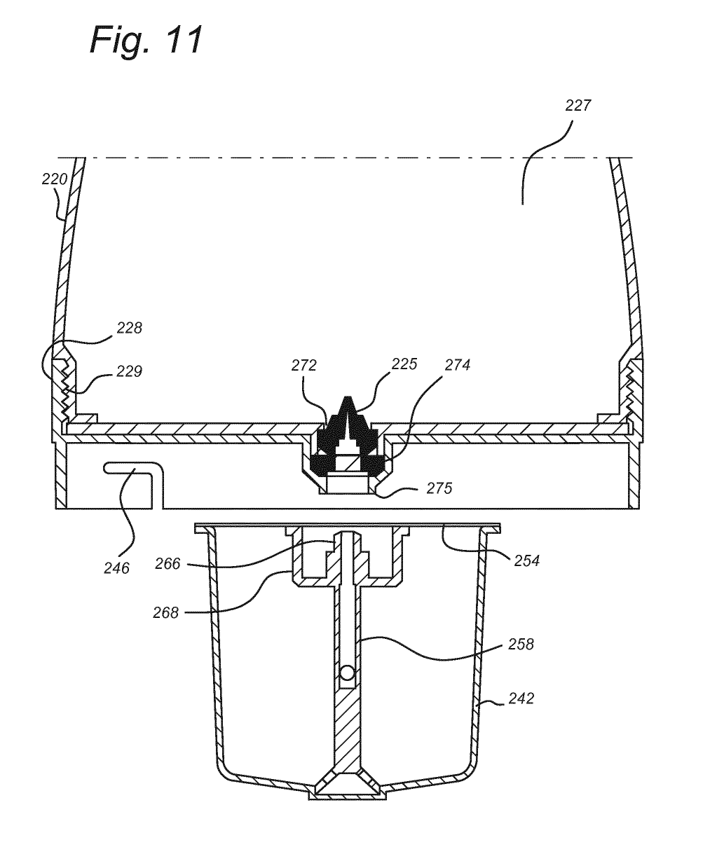

A third embodiment of the invention is shown according to FIG. 11, which depicts an alternative valve arrangement and coupling to that described in the first embodiment. Like elements to the first embodiment are denoted by like reference numerals preceded by 200.

According to FIG. 11, a nursing bottle 220 has a base 228 connected thereto by a suitable screw connection 229. The base 228 has a liquid inlet 272 providing access to the interior space 227 of the bottle 220. The liquid inlet 272 terminates at a lower rim 275. A one-way valve 225 is located within the liquid inlet 272. Also located beneath the one-way valve 225 within the rim 275 is a sealing washer 274. A bayonet flange 246 surrounds the liquid inlet 272 providing a stable support for the bottle 220 and connection to an infant formula supply device (not shown).

Capsule 242 is also distinct from the capsule of the first embodiment in that spike 258 carries a cup 268 adjacent to its blunt point 266. The cup 268 engages against the underside of the foil 254. Other features of the capsule 242 may be substantially similar to the first embodiment and are not discussed further here.

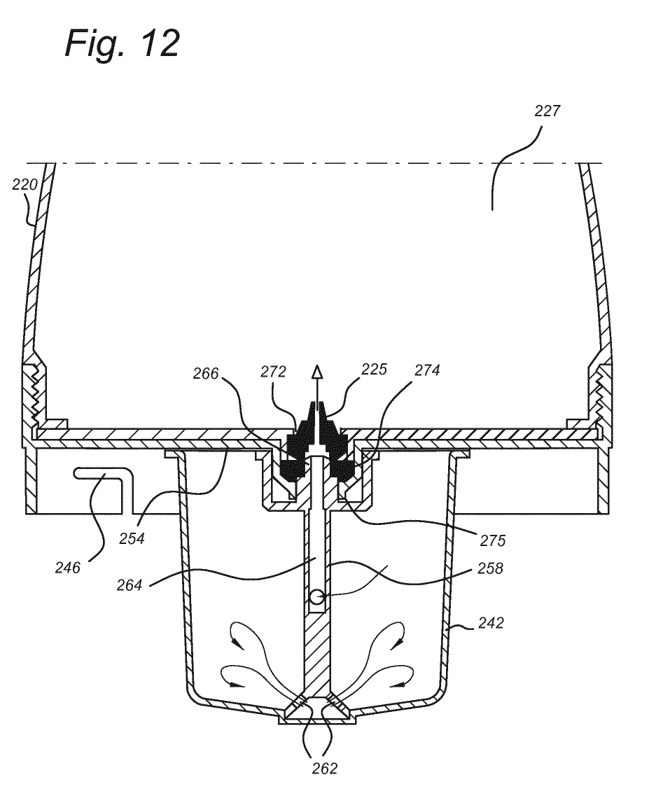

FIG. 12 shows the third embodiment of FIG. 11 with the bottle 220 engaged with the capsule 242 which may be carried in a recess of an infant formula supply device as in the first embodiment. As can be seen, the rim 275 has engaged the foil 254 and caused it to rupture over the blunt point 266. The blunt point 266 is furthermore engaged within the sealing washer 274. In this manner, a liquid-tight connection is formed from the internal chamber 256 of the capsule 242 into the interior space 227 of the bottle 220 via the outlet opening 262, the lumen 264 and liquid inlet 272. Further operation of the third embodiment is as described in relation to the first embodiment.

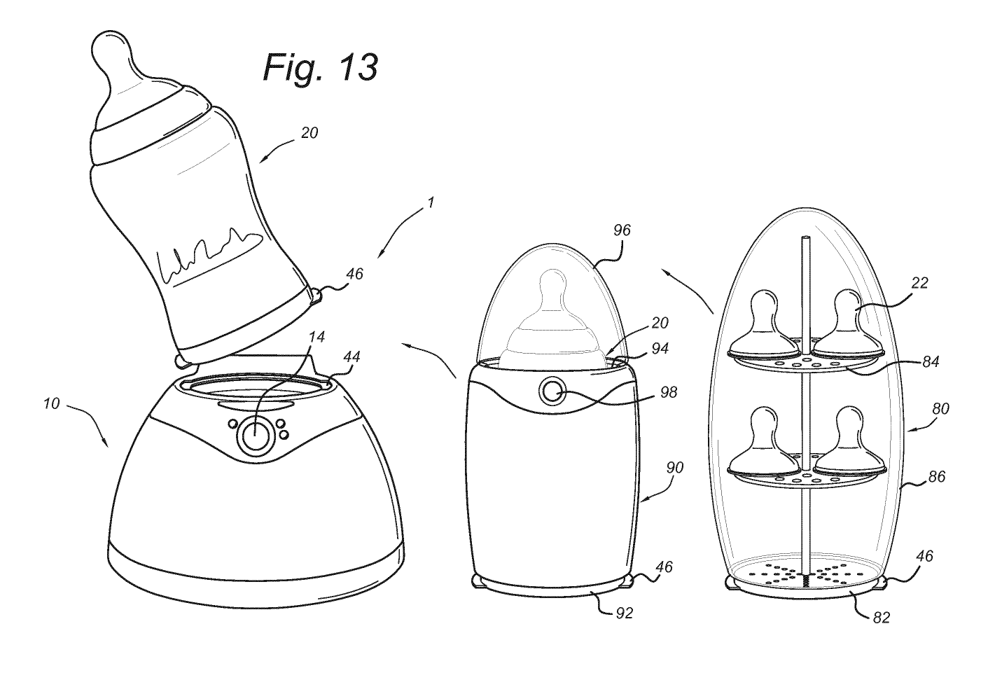

FIG. 13 shows a perspective view of the system 1 according to the first embodiment of the invention including a number of additional accessories. According to FIG. 13, there is shown a steriliser unit 80, and a food or bottle warmer unit 90. Both units 80, 90 have base portions 82, 92 respectively provided with bayonet lugs 46 for attachment to the supply device 10 once the bottle 20 has been removed. As shown, the steriliser unit 80 contains a rack 84 on which are placed a number of teats 22 for sterilising. Other items and parts of a nursing bottle may also be located within the steriliser unit 80 for sterilising. The rack 84 is covered by a dome 86. The supply device 10 can be activated via the user interface 14 to deliver steam to the dome 86 to perform a sterilising function. The details of the sterilising function may be pre-programmed in the controller 36. The bottle warmer unit 90 comprises a basin 94 into which a nursing bottle 20 or other recipient can be placed. The basin 94 is closed by a cover 96 and has a temperature indicator 98 on its front surface. On attachment of the bottle warmer unit 90 to the supply device 10, a user can activate the user interface 14 to supply hot water to the basin 94. When the bottle 20 reaches a desired temperature, the indicator 98 signals this to a user. The skilled person will be familiar with suitable indicator arrangements and temperature sensors that may perform this function.

Although two additional accessories have been shown, the skilled person will be well aware that other accessories and modules could also be integrated into the system as described above.

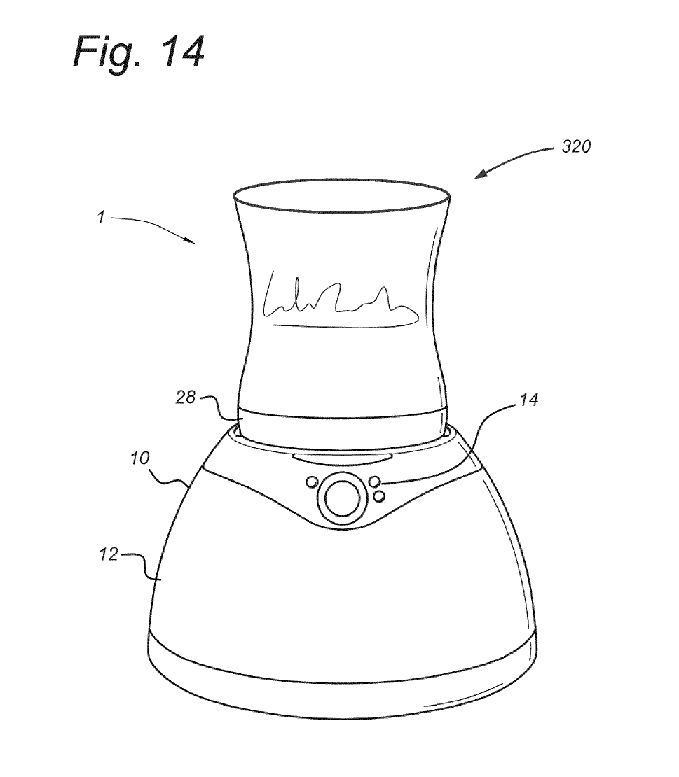

FIG. 14 shows a perspective view of the system 1 according to the an embodiment of the invention including an accessory in the form of a beaker 320, such as a cup, mug, travel mug, or the like, provided with a base 28 similar to those of the nursing bottles described above.

In this example, the capsule could contain any suitable beverage concentrate such as teas, coffees, medicated formulations, or nutritional drinks, including pregnancy drinks, breast feeding formulations, isotonic drinks, nutritional drinks for elderly people, or the like. In this example, operation would be substantially as with respect to any of the previous examples, and this will not therefore be described in any further detail. It will be appreciated however that in this instance the supply device 10 need not be used for preparation of infant formula, and can be used more generally as a beverage supply device 10. Accordingly, reference to the supply device 10 being an infant formula supply device 10 is not intended to be limiting, but rather is for the purpose of illustrating one particular example use.

Although not shown, the proximity detector 35 provided on the supply device 10 may be arranged to detect the type of accessory presented and indicate to the controller 36 the correct program to implement.

Thus, the invention has been described by reference to certain embodiments discussed above. Many modifications in addition to those described above may be made to the structures and techniques described herein without departing from the spirit and scope of the invention. Accordingly, although specific embodiments have been described, these are examples only and are not limiting upon the scope of the invention as defined by the attached claims.

In the claims, any reference signs placed between parentheses shall not be construed as limiting the claim. The word ‘comprising’ does not exclude the presence of other features or steps then those listed in a claim. Furthermore, the words ‘a’ and ‘an’ shall not be construed as limited to ‘only one’, but instead are used to mean ‘at least one’, and do not exclude a plurality. For example, the nursing bottle may have a base having only one liquid inlet, or a plurality (e.g. two) of liquid inlets. The mere fact that certain measures are recited in mutually different claims does not indicate that a combination of these measures cannot be used to advantage.

For example, the system can be configured such that it prepares the infant formula with the correct amount of water (the correct water amount generally depending on the amount of concentrated infant formula used, as will be clear to the skilled person), wherein all the water passes a said formula mixing chamber (or capsule). In an alternative embodiment, the system can be configured such that a first part of the total correct amount of water passes the formula mixing chamber (or capsule), wherein a remaining second part of the total correct amount of water bypasses the formula mixing chamber (or capsule). In the latter case, for example, the system may include a mixing chamber bypass to feed water directly into the bottle, bypassing the mixing chamber (or capsule).

According to the above, there is provided a system for the preparation of nursing bottles comprising: an infant formula supply device for delivering a dose of liquid through a liquid outlet; a nursing bottle having an upper portion for affixing a drinking teat and a base having a liquid inlet; a coupling interface for connecting the formula supply device to the base of the nursing bottle, whereby the liquid can flow into the bottle via the liquid inlet.

By filling the bottle through its base, the construction of the infant formula supply device can be kept significantly smaller than known devices which fill the bottle through its neck. Furthermore, the teat can be assembled to the nursing bottle in advance of filling and once the formula is dispensed to the bottle, the infant may be fed directly without further manipulation. In the present context, it will be understood that the coupling interface may comprise complementary arrangements on both the supply device and on the nursing bottle. It may also be formed as a separate item of manufacture. It is understood that its function is to allow connection of both parts of the system such that the desired liquid transfer can occur.

The system may also comprise further components and accessories, including but not limited to: sterilisers; food warmers; drink makers; sterile water dispensers; beakers; blenders and the like. Preferably such components are provided in modular form and are attachable to the infant formula supply device via the coupling interface. For the purpose of sterilising and the delivery of sterile water, the system may be provided with appropriate filters, in particular microbial filters. The infant formula supply device may also be controllable to perform a plurality of functions in combination with such components and is thus not limited to the supply of infant formula.

For example, the above techniques can also be applied more generally to the delivery of beverages. The concentrated beverage may be in liquid, powder or any other available form, and typically includes a quantity corresponding to a single dose of liquid beverage, so that the capsules can be provided as single use capsules. The nature of the beverage will depend upon the particular application. When the beverage receptacle used is a nursing bottle, the beverage concentrate is typically a liquid or powdered infant formula, which when diluted with a suitable quantity of water results in a single dose of liquid infant formula. However, it will be appreciated that the techniques can be applied to any suitable beverage, such as teas, coffees, medicated formulations, or nutritional drinks, including pregnancy drinks, breast feeding formulations, isotonic drinks, nutritional drinks for elderly people, or the like, and reference to infant formula is not intended to be limiting. Additionally, the beverage can be formed through a variety of processes, including diluting, reconstituting, infusing, or the like.

In addition to the system as a whole, the above also provides an infant formula supply device for delivering a dose of liquid through a liquid outlet to a liquid inlet in a base of a nursing bottle for the preparation of an infant feed, the supply device comprising a coupling interface for connecting the supply device to the base of the nursing bottle, whereby the liquid can flow into the bottle via the liquid inlet. The advantages of such a device are as described above.

Depending upon the configuration of the device, it may supply water at the correct temperature to concentrated formula provided within the bottle. Preferably however, the device comprises a source of water and a formula mixing chamber in communication with the source of water. The concentrated infant formula can then be mixed with water in the mixing chamber and delivered to the liquid outlet. The source of water may be a reservoir provided on or in the device or may be a connection to an external source such as a mains supply. The reservoir may be removed for filling or filled directly when connected to machine. Furthermore, the concentrated infant formula may be in liquid, powder or any other available form.

The device may operate with a supply of concentrated infant formula sufficient for making-up a number of feeds the term “a number” including “one” and “a plurality”. Alternatively, a user may measure a dose of formula into the mixing chamber prior to use. In a most preferred embodiment, the device is intended for use with capsules of infant formula. Such capsules may be re-fillable but are preferably of the pre-filled single-use variety. The mixing chamber may then be arranged to receive a single-use capsule containing the concentrated infant formula. In such an embodiment, the interface may comprise a piercing element for piercing the capsule, either through a body portion or e.g. through a cover portion. Alternatively, a user might tear or peel-off a foil or cover layer before inserting the capsule into the device In this case, the capsule may also be considered as the mixing chamber and the liquid outlet may be provided as part of the capsule or as a disposable accessory. An advantage of such an arrangement is that certain parts of the supply device that come into contact with the infant formula may be disposable.

A said piercing element may be configured in various ways. For example, the bottle may be provided with the piercing element, for example a cannula that penetrates a section of the capsule (e.g. a piercable membrane) when the bottle and capsule are moved towards each other. In another embodiment, the capsule may include the piercing element, for example an internal spike that can pierce a section of capsule when that section is moved through a proximal spike part or when a proximal spike part is moved through that capsule section.

According to a further aspect of the above, the interface may comprise a valve actuator, arranged to selectively open the liquid inlet at the base of the nursing bottle. The skilled person will be familiar with many different valve members that can achieve this function, including rods, nozzles, levers or the like, which may be selected according to the nature of a valve provided at the liquid inlet. Alternatively, the liquid inlet may be opened by pressure alone with no valve actuator required.

In a preferred embodiment, the interface comprises a mechanical connection to the base of the bottle. Such a mechanical connection is advantageous in providing a stable structure which will not be easily knocked-over. The mechanical connection may also form part of an interlock, preventing operation of the device if the bottle is not present or if it is incorrectly attached. This may reduce the risk of accidents and leakage.

Most preferably, the device includes a heater for heating the dose of liquid prior to delivery to the bottle. In the event that mixing of water and concentrated formula takes place, heating of the water preferably takes place prior to mixing. The heater is preferably capable of heating water to a temperature suitable for sterilising or decontaminating purposes and may also produce steam.

In accordance with a further aspect of the above arrangements, the device further comprises a source of pressure for pressurising the dose of liquid for delivery. The source of pressure may comprise a pump although the skilled person will be aware that other alternative sources of pressure could be considered, including the use of heat to generate pressure in the form of steam.

In a most preferred embodiment of the above arrangements, the nursing bottle may have a liquid inlet located at an underside of the base. In this case, the liquid outlet may be oriented in use to direct the dose of liquid upwards into the nursing bottle. It will nevertheless be understood that other directions of entry may be considered, depending upon the design of the nursing bottle and its base. In particular, lateral inflow in the base region could also achieve similar advantages.

The device according to the above arrangements may further comprise a controller for controlling operation of the device. The controller may be in the form of a microprocessor or the like and may be pre-programmed to carry out any of a number of desired procedures.

The procedures may be determined on the basis of sensed parameters or may be selected by a user on-demand. For this purpose, the device may be provided with a user-interface operatively connected to the controller.

The device may further be configured to be remote controlled, e.g. by providing the infant formula supply device with a communication device that cooperates with the controller, is connected to the controller, or is part of the controller. Remote control may include wired or wireless remote control. In a further embodiment, the communication device may be configured to be part of or communicatively coupled to a digital communication network (e.g. a computer network and/or digital telephone network). As an example, remote control of the infant formula supply device may be achieved via a remote control connection such as e.g. a Wi-Fi connection, an Ethernet connection, a Bluetooth™ connection, or differently, as will be appreciated by the skilled person. To that aim, the infant formula supply device may include a communication device that is configured to communicate via a said remote control connection. The remote control may e.g. be used:
for updating the infant formula supply device, for example to update software or firmware (if any) of the controller, in which case the controller may be configured to be updated via the remote control;
for activating and/or deactivating the infant formula supply device, to which aim the controller may be configured to activate and/or deactivate the infant formula supply device upon receiving activation and/or deactivation control signals via the remote control;
for obtaining status information from the infant formula supply device (in which case the infant formula supply device may be configured to transmit such information upon an information request received via the remote control); and/or
a different remote control application.

Communication to the infant formula supply device by remote control, e.g. via a digital communication network, may e.g. be effected via a remote user interface, for example by a remove controller, computer or Smartphone, configured to provide such a remote user interface.

Various parameters may be sensed in order to determine operation of the device. In the event of a capsule based system, data relating to the capsules may be sensed e.g. by reading data provided on the capsule. Furthermore, water temperature, bottle identity and bottle temperature may be determined, and/or filter stand time, pressure drop in the system. Most preferably, a detection element is arranged to provide a signal to the controller in response to detection of the base of the nursing bottle.

The above arrangements furthermore relates to a nursing bottle especially adapted for use in the system and with the device as described above. The nursing bottle preferably has an upper portion provided with or suitable for affixing a drinking teat and a base having a liquid inlet. The nursing bottle further comprises a coupling interface for coupling the nursing bottle to an infant formula supply device for filling of the nursing bottle through the liquid inlet. Nursing bottles exist with air inlets provided at their base in order to prevent formation of a vacuum as the infant drinks. Such bottles are generally not adapted to be filled through these air inlets and do not have provision for connection to an infant formula supply device.

In one preferred embodiment, the interface may comprise a piercing element for engagement with a pierceable element on the supply device. The piercing element may be sharp or blunt and may be shielded to prevent access or injury by a carer or infant.

According to a further preferred embodiment, the interface may comprise a selectively operable valve, arranged to open the liquid inlet on connection of the bottle to the supply device. The valve may subsequently close on disconnecting the bottle, thereby preventing leakage.

According to a still further preferred embodiment, the selectively operable valve is a pressure actuated, one-way valve. Such a valve may be opened by over pressure on the liquid supply side to allow entry of water or infant formula into the bottle. The valve may also subsequently function as an air entry valve, opening in the presence of vacuum within the bottle. The skilled person will be well aware of suitable valves that may be used, including duck-bill valves, diaphragm valves, flap valves and the like.

In an alternative embodiment, the selectively operable valve may be arranged to be opened by engagement by a valve member carried by the supply device.

As discussed above in relation to the supply device, the coupling interface may comprise a mechanical connection allowing the nursing bottle and the supply device to be connected together. The connection may be any appropriate mechanical connection including bayonet, screw, click, latch, slide or the like.

In a most preferred embodiment, the liquid inlet is located at an underside of the base. In such a configuration, liquid will then flow upwards into the nursing bottle during filling.

Although the arrangements have been described with mixing taking place within a mixing chamber or capsule provided within the supply device, the skilled person will also be aware that such a chamber or capsule could alternatively be provided in a coupling interface portion forming part of the bottle. This may have the advantage that portions of the interface being in contact with infant formula may more easily be cleaned.

According to a still further aspect of the above arrangements, in the case of mixing of concentrated infant formula in a capsule, there may be provided an agitating arrangement arranged to agitate the infant formula in the capsule for better mixing with the water. Such an agitating arrangement may vibrate or otherwise move the capsule or other portions of the system in order to induce mixing. Such movement may take place at relatively low frequencies or even using ultra-sound.

Additionally, the above arrangements relate to a capsule for use with the device, bottle and systems as described herein. The capsule may be a refillable and re-usable item that can be filled with the correct dosage of concentrated infant nutrition by a user. The capsule preferably comprises means for sealing engagement with a nursing bottle and with a liquid supply device in order to allow liquid to pass from the supply device through the capsule to the bottle.

Most preferably, the capsule is a pre-packaged single-use capsule containing a dose of concentrated infant formula. The capsule may comprise a bottom, a circumferential wall and a closing foil defining an internal chamber containing the concentrated infant formula. Although reference is given to a circumferential wall, it will be understood that this is not limiting on the shape of the capsule which may be of any suitable cross-sectional shape, including e.g. circular, oval, square, rectangular, hexagonal or octagonal. The closing foil may comprise a single or multi-layer film that can be pierced, ruptured or removed to access the contents. The means for sealing engagement may comprise suitable means located inside the capsule prior to use for engaging with corresponding provisions on a bottle or liquid supply device. In a most preferred embodiment, the capsule comprises a spike, which may carry an abutment for engaging with the underside of the bottle in order to provide an improved seal. Other elements including filters and agitation devices may be provided within the capsule, instead or in addition to provisions within the supply device or bottle.

The above arrangements furthermore relates to a method of preparing a nursing bottle having an upper portion for affixing a drinking teat and a base having a liquid inlet, the method comprising: engaging the liquid inlet with a liquid outlet of an infant formula supply device; and supplying liquid from the liquid outlet through the liquid inlet to fill the nursing bottle through its base. In this context, filling the bottle through its base is understood to encompass any filling that does not take place through the neck of the bottle as is conventional. Filling may thus take place with the teat in place on the bottle. Bottles having integrated teats may also be used. In particular, the infant formula supply device may be as described above and the supply of liquid may include mixing water and concentrated infant formula.

The concentrated infant formula may be supplied and/or mixed in a capsule, which may be a pre-filled, single-use capsule. Accordingly, the method preferably comprises providing a single-use capsule containing concentrated infant formula and supplying water through the capsule to produce reconstituted infant formula for delivery to the nursing bottle.

The method may further incorporate any of the procedures as described above to facilitate filling of the bottle on connection to the supply device. In particular, the method may include controlling the supply device on the basis of signals received in response to the presence of the bottle.

Whilst some of the advantages have been described as being specific to nursing bottles and infant formulas, it will be apparent that these could apply to beverage receptacles and beverage receptacles more generally, and therefore these advantages will not be described further.

1. A beverage supply device for delivering a dose of liquid through a liquid outlet to a liquid inlet in a base of a beverage receptacle for the preparation of a beverage, the supply device comprising a coupling interface for connecting the supply device to the base of the beverage receptacle, whereby the liquid flows into the beverage receptacle via the liquid inlet, wherein a replaceable accessory is connectable to the beverage supply device or the coupling interface in the place of the beverage receptacle, the replaceable accessory being selected from the group comprising: a sterilizing unit; a bottle warming unit; a food warming unit; a drink warming unit; a sterile water dispenser; a blender; and a drink maker.

2. The device according to claim 1, further comprising a source of water and a mixing chamber in communication with the source of water, whereby concentrated beverage can be mixed with water in the mixing chamber and delivered to the liquid outlet.

3. The device according to claim 2, wherein the mixing chamber is a single use capsule containing concentrated beverage.

4-64. (canceled)

65. The device according to claim 2, wherein the coupling interface comprises at least one of:
a piercing element for piercing the capsule;
a valve actuator, arranged to selectively open the liquid inlet; and,
a mechanical connection to the base of the beverage receptacle.

66. The device according claim 1, further comprising a heater for heating the dose of liquid prior to delivery.

67. The device according to claim 66, wherein the heater heats water prior to water being mixed with concentrated beverage.

68. The device according to claim 1, further comprising a source of pressure for pressurising the dose of liquid for delivery.

69. The device according to claim 1, for a beverage receptacle having the liquid inlet located at an underside of the base, wherein the liquid outlet is oriented in use to direct the dose of liquid upwards into the beverage receptacle.

70. The device according to claim 1, further comprising at least one of:
a controller for controlling operation of the device;
a user-interface operatively connected to the controller; and,
a detection element, arranged to provide a signal to the controller in response to detection of the base of the beverage receptacle.

71. The device according to claim 1, wherein the beverage receptacle is at least one of a beaker and a nursing bottle.

72. The device according to claim 1, wherein the beverage is an infant formula.

73. A system for the preparation of beverages comprising:
a beverage supply device for delivering a dose of liquid through a liquid outlet;
a beverage receptacle having a base having a liquid inlet; and,
a coupling interface for connecting the supply device to the base of the beverage receptacle, whereby the liquid flows into the beverage receptacle via the liquid inlet in use, wherein the system further comprises a replaceable accessory, connectable to the beverage supply device or the coupling interface in the place of the beverage receptacle, the replaceable accessory being selected from the group comprising: a sterilizing unit; a bottle warming unit; a food warming unit; a drink warming unit; a sterile water dispenser; a blender; and a drink maker.

74. The system according to claim 73, further comprising a capsule containing a quantity of concentrated beverage to be mixed with water for delivery to the beverage receptacle.

75. The system according to claim 74, further comprising an agitating arrangement arranged to agitate a content of the capsule, for example to agitate the beverage in the capsule for mixing with the water.

76. The system according to claim 74, wherein the capsule is a pre-packaged single-use capsule.

77. The system according to claim 73, the beverage receptacle further comprising a coupling interface for coupling the beverage to the beverage supply device for filling of the beverage receptacle through the liquid inlet.

78. The system according to claim 77, wherein the beverage receptacle is a nursing bottle having an upper portion for affixing a drinking teat and the base having the liquid inlet.

79. The system according to claim 77, wherein the coupling interface comprises at least one of:
a piercing element for engagement with a pierceable element on the supply device;
a selectively operable valve, arranged to open to allow flow through the liquid inlet;
a mechanical connection to the supply device; and,
a mixing chamber in which concentrated beverage can be mixed with water and delivered to the liquid inlet.

80. The system according to claim 79, wherein the selectively operable valve is a pressure actuated, one-way valve.

81. The system according to claim 80, wherein the selectively operable valve is opened by engagement by a valve actuator carried by the supply device.

82. A beverage supply device for delivering a dose of liquid through a liquid outlet to a liquid inlet in a base of a beverage receptacle for the preparation of a beverage, the supply device comprising a coupling interface for connecting the supply device to the base of the beverage receptacle, whereby the liquid flows into the beverage receptacle via the liquid inlet in use, wherein the device further comprises a source of water and a mixing chamber in communication with the source of water, whereby concentrated beverage can be mixed with water in the mixing chamber and delivered to the liquid outlet.

83. The device according to claim 82, wherein the mixing chamber is a single use capsule containing concentrated beverage.

84. The device according to claim 82, wherein the coupling interface comprises at least one of:
a piercing element for piercing the capsule;
a valve actuator, arranged to selectively open the liquid inlet; and
a mechanical connection to the base of the beverage receptacle.

85. The device according to claim 82, further comprising a heater for heating the dose of liquid prior to delivery.

86. The device according to claim 85, wherein the heater heats water prior to water being mixed with concentrated beverage.

87. The device according to claim 82, further comprising a source of pressure for pressurising the dose of liquid for delivery.

88. The device according to claim 82, for a beverage receptacle having the liquid inlet located at an underside of the base, wherein the liquid outlet is oriented in use to direct the dose of liquid upwards into the beverage receptacle.

89. The device according to claim 82, further comprising at least one of:
a controller for controlling operation of the device;
a user-interface operatively connected to the controller; and
a detection element, arranged to provide a signal to the controller in response to detection of the base of the beverage receptacle.

90. The device according to claim 82, wherein the beverage receptacle is at least one of a beaker and a nursing bottle.

91. The device according to claim 90, wherein the beverage is an infant formula.

92. A system for the preparation of beverage receptacles comprising:
a beverage supply device for delivering a dose of liquid through a liquid outlet;
a beverage receptacle having an upper portion for affixing a drinking teat and a base having a liquid inlet;
a coupling interface for connecting the beverage supply device to the base of the beverage receptacle, whereby the liquid flows into the beverage receptacle via the liquid inlet in use, wherein system further comprises a capsule containing a quantity of concentrated beverage to be mixed with water for delivery to the beverage receptacle.

93. The system according to claim 92, further comprising an agitating arrangement arranged to agitate a content of the capsule, for example to agitate the beverage in the capsule for mixing with the water.

94. The system according to claim 92, wherein the capsule is a pre-packaged single-use capsule.

95. The system according to claim 92, further comprising a replaceable accessory, connectable to the beverage supply device or the coupling interface in the place of the beverage receptacle, the replaceable accessory being selected from the group comprising: a sterilizing unit; a bottle warming unit; a food warming unit; a drink warming unit; a sterile water dispenser; a blender; a beaker; and a drink maker.

96. The system according to claim 92, the beverage receptacle further comprising a coupling interface for coupling the beverage to the beverage supply device for filling of the beverage receptacle through the liquid inlet.

97. The system according to claim 96, wherein the coupling interface comprises at least one of:
a piercing element for engagement with a pierceable element on the supply device;
a selectively operable valve, arranged to open to allow flow through the liquid inlet;
a mechanical connection to the supply device; and,
a mixing chamber in which concentrated beverage can be mixed with water and delivered to the liquid inlet.

98. The system according to claim 96, wherein the selectively operable valve is at least one of:
a pressure actuated, one-way valve; and,
opened by engagement by a valve actuator carried by the supply device.

99. A nursing bottle having an upper portion for affixing a drinking teat and a base having a liquid inlet, the nursing bottle further comprising a coupling interface for coupling the nursing bottle to an infant formula supply device for filling of the nursing bottle through the liquid inlet, wherein the liquid inlet is located at an underside of the base, whereby in use liquid flows upwards into the beverage receptacle.

100. The bottle according to claim 99, wherein the coupling interface comprises at least one of:
a piercing element for engagement with a pierceable element on the supply device;
a selectively operable valve, arranged to open to allow flow through the liquid inlet;
a mechanical connection to the supply device; and,
a mixing chamber in which concentrated beverage can be mixed with water and delivered to the liquid inlet.

101. The bottle according to claim 100, wherein the selectively operable valve is at least one of:
a pressure actuated, one-way valve; and
opened by engagement by a valve actuator carried by the supply device.

102. A pre-packaged single-use capsule comprising a bottom, a circumferential wall and a closing foil defining an internal chamber containing a dose of concentrated beverage, further comprising means for sealing engagement with a liquid supply device and with a base of a beverage receptacle allowing the contents of the capsule to be delivered upwards from the capsule into the bottle.

103. A method of preparing a beverage receptacle having an upper portion for affixing a drinking teat and a base having a liquid inlet, the method comprising:
engaging the liquid inlet with a liquid outlet of an beverage supply device; and
supplying liquid from the liquid outlet through the liquid inlet to fill the beverage receptacle through its base, wherein the method further comprises providing a single-use capsule containing concentrated beverage and the method comprises supplying water through the capsule to produce reconstituted beverage for delivery to the beverage receptacle.
